(19) United States
(12) Patent Application Publication
(10) Pub. No.: US 2015/0020815 A1
(43) Pub. Date: Jan. 22, 2015

(54) Protective Mask with Imbedded Functionality

(71) Applicants: Pamela Gabriel, Greenwich, CT (US); Robert P. Gabriel, Greenwich, CT (US)

(72) Inventors: Pamela Gabriel, Greenwich, CT (US); Robert P. Gabriel, Greenwich, CT (US)

(21) Appl. No.: 14/334,207

(22) Filed: Jul. 17, 2014

Related U.S. Application Data
(60) Provisional application No. 61/847,385, filed on Jul. 17, 2013.

(51) Int. Cl. A41D 13/11; H04R 1/08; H04R 1/10

(52) U.S. Cl. CPC A41D 13/1161; H04R 1/105; H04R 1/1008; H04R 1/083; H04R 1/1091
USPC 128/863

(57) ABSTRACT

Disclosed is a protective mask with imbedded functionality and an interchangeable face panel. The protective mask includes an upper support that extends across a wearer's face and a lower support extending downward therefrom so that the mask covers the wearer's nose and chin, leaving the eyes uncovered. The each of the ends of the upper support includes an earphone, whereby each of the earphones includes a microphone, a speaker, a wireless headphone circuitry, a power source, and related components enclosed therein. The wireless headphone circuitry includes a wireless transceiver and an antenna assembly that communicates with an external electronic device. The wireless transceiver is connected to a processor that can decode input signals to emit sound through the speaker, and that can process speech into a signal for transmission. In this way, the present invention provides a hands-free and a wireless method of communicating with external electronic devices.

### CROSS REFERENCE TO RELATED APPLICATION

This application claims the benefit of U.S. Provisional Application No. 61/847,385 filed on Jul. 17, 2013. The above identified patent application is herein incorporated by reference in its entirety to provide continuity of disclosure.

### BACKGROUND OF THE INVENTION

### Field of the Invention

The present invention relates to a protective mask. More specifically, the present invention pertains to an improved protective mask with imbedded functionality. The protective mask includes a wire frame with a removably attached mask portion. Each of the ends of the wire frame comprises an earphone thereon. In one embodiment, the earphone comprises a microphone, a speaker, and a wireless headphone circuitry to enable the wearer to utilize external electronic devices.

Protective masks are worn to afford protection to the wearer's face. Protective masks are configured to cover the nose and mouth of the wearer. In this way, protective masks generally filter the outside air and protect the face against airborne objects or dangerous environments, while allowing vision. Conversely, protective masks also block exhaled particles and respiratory excretions of the wearer. Thus, protective masks are worn in various environments such as hospitals, kitchens, laboratories, workshops, construction sites, and other such venues.

Conventional protective masks, however, are typically ill-fitting because they are available in one size. Even though some masks may include adjustable straps to secure to the wearer's face, these masks are not configured to follow the contours of the wearer's face. Thus, conventional protective masks may not provide an adequate barrier or a seal against the outside environment when worn. Additionally, conventional protective masks are designed to be disposable, and are composed of cloth-like material that may be discarded after a single use. Thus, it can be wasteful and costly to utilize disposable protective masks.

Furthermore, individuals who wear the protective masks may desire to utilize electronic devices while engaging other tasks. This may not be feasible, however, when the wearers have contaminants on their hands, or are otherwise unable to hold electronic devices in their hands. Therefore, a protective mask that is designed to comfortably fit the wearer's face while enabling the wearer to utilize electronic devices in a hands-free manner is desired.

The present invention provides a protective mask having an upper support and a lower support. The upper and lower supports are flexible and are configured to ergonomically fit over the wearer's face. Each of the upper and lower supports comprises a first end and a second end. The first end and the second end of the lower supports are connected to the upper support so that the two supports are unitary in structure and the lower support extends below the upper support. The lower support is adapted to cover the wearer's nose and mouth and comprises a removably secure a face panel thereon. The first and second ends of the upper support are secured over the wearer's ears for so that the face panel is in position over the mouth and the nose of the wearer.

Each of the first end and the second end of the upper support comprises an earphone thereon. The earphone comprises a speaker, an audio amplifier, a microphone, a processor, a wireless transceiver, an antenna assembly, a power source, and related components imbedded therein. The wireless transceiver is operable via a power button that is connected to the power source, which comprises a battery. The wireless transceiver and the antenna assembly can communicate wirelessly with an external electronic device having wireless capability by receiving and transmitting signals. The processor can decode input signals from external electronic devices and apply output signals in form of audible sound through the speaker. The speaker can also apply input signal from the microphone to transmit it to external electronic devices. In this way, the wearer can listen to music, transmit voice commands, and communicate with the external electronic device in a wireless and a hands-free manner.

### DESCRIPTION OF THE PRIOR ART

Devices have been disclosed in the prior art that claim protective masks for various uses. These include devices that have been patented and published in patent application publications. The prior art devices generally disclose protective masks having straps, loops, and ties that hold the mask in position over the wearer's mouth and nose. These devices, however, do not disclose a protective mask with imbedded functionality for playing music and communicating on a mobile device. The foregoing is a list of devices deemed most relevant to the present disclosure, which are herein described for the purposes of highlighting and differentiating the unique aspects of the present invention, and further highlighting the drawbacks existing in the prior art.

Specifically, U.S. Pat. No. 7,836,887 to Kling discloses a protective mask having a malleable wire frame that is connected to a filtration bag by means of a tether. The filtration bag is adapted to cover a wearer's mouth and nose. The wire frame can be bent to fit the wearer's face. Unlike the present invention, however, the wire frame does not comprise any imbedded functionality. The present invention comprises a wire frame with imbedded electronic features such as wireless capability for interacting with other electronic devices, an imbedded microphone, and imbedded speakers. In this way, the wearer can listen to music and communicate on a mobile device while wearing the mask.

U.S. Pat. No. 5,717,991 to Nozaki, U.S. Pat. No, 7,044,131 to Griesbach, and U.S. Pat. No. 5,819,731 to Dyrud disclose protective masks having a mask body and a strap system attached thereto. These devices generally comprise a strap that encircles a wearer's head, and a pair of straps that wrap around the wearer's ears. While the foregoing Nozaki, Griesbach, and Dyrud devices disclose a protective mask, these devices differ from the present invention in that these devices do not comprise a metal frame having imbedded functionalities therein. The present invention comprises a metal frame having a removably attached mask. The metal frame comprises a defined interior volume having electrical components to provide wireless capability means for interacting with other electronic devices, an imbedded microphone, and imbedded speakers.

Finally, U.S. Pat. No. 5,561,863 to Gerald discloses a surgical protective mask comprising a see-through portion and a porous portion wherein the see-through portion is adapted for viewing a wearer's mouth. The mask is substantially rectangular in shape and comprises four corners. Each of the corners comprises a strap. The straps may be tied to form a pair of loops so that each loop can be worn on the wearer's ear. While Gerald discloses a protective mask, the design and intent of the Gerald device differ from the present invention in that the present invention intends to provide a protective mask with imbedded functionality. In contrast, Gerald discloses a protective mask that comprises multiple sections wherein each section is composed of a different material.

The devices disclosed in the prior art have several known drawbacks. These devices do not comprise a frame and a mask, wherein the mask is removably attached to the frame, so that the frame may be used with a number of different masks. Additionally, the prior art devices do not comprise wireless capability and a means to utilize other electronic devices in a hands-free manner. The present invention overcomes these limitations by disclosing a protective mask frame having imbedded functionality. The earphones of the mask frame comprise a hollow interior having a microphone, speakers, wireless capability means, and related components. It is therefore submitted that the present invention is substantially divergent in design elements from the prior art, and consequently it is clear that there is a need in the art for an improvement to protective masks. In this regard, the instant invention substantially fulfills these needs.

### SUMMARY OF THE INVENTION

In view of the foregoing disadvantages inherent in the known types of protective masks now present in the prior art, the present invention provides a new and improved protective mask with imbedded functionality wherein the same can be utilized for creating a physical barrier between the mouth and nose of the wearer and any contamination while enabling wearer to use other electronic devices in a hands-free manner.

It is therefore an object of the invention to provide a new and improved protective mask with imbedded functionality that has all of the advantages of the prior art and none of the disadvantages.

Another object of the present invention is to provide a new and improved protective mask that comprises a mask frame and an interchangeable face panel that is removably attached to the mask frame.

Yet another object of the present invention is to provide a new and improved protective mask with imbedded speakers and microphone to allow a wearer to communicate with other electronic devices.

Still yet another object of the present invention is to provide a new and improved protective mask that is ergonomically shaped.

Other objects, features, and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein the numeral annotations are provided throughout.

FIG. 1 shows a perspective view of an embodiment of the present invention.

FIG. 2 shows a perspective view of another embodiment of the present invention.

FIG. 3 shows a view of the present invention as worn.

FIG. 4 shows an exemplary schematic diagram of the earphone of the present invention.

### DETAILED DESCRIPTION OF THE INVENTION

References are made herein to the attached drawings. Like reference numerals are used throughout the drawings to depict like or similar elements of the protective mask with imbedded functionality. For the purposes of presenting a brief and clear description of the present invention, the preferred embodiment will be discussed as used to create a physical barrier between the mouth and nose of the wearer and any contamination while enabling wearer to use other electronic devices in a hands-free manner. The figures are intended for representative purposes only and should not be considered to be limiting in any respect.

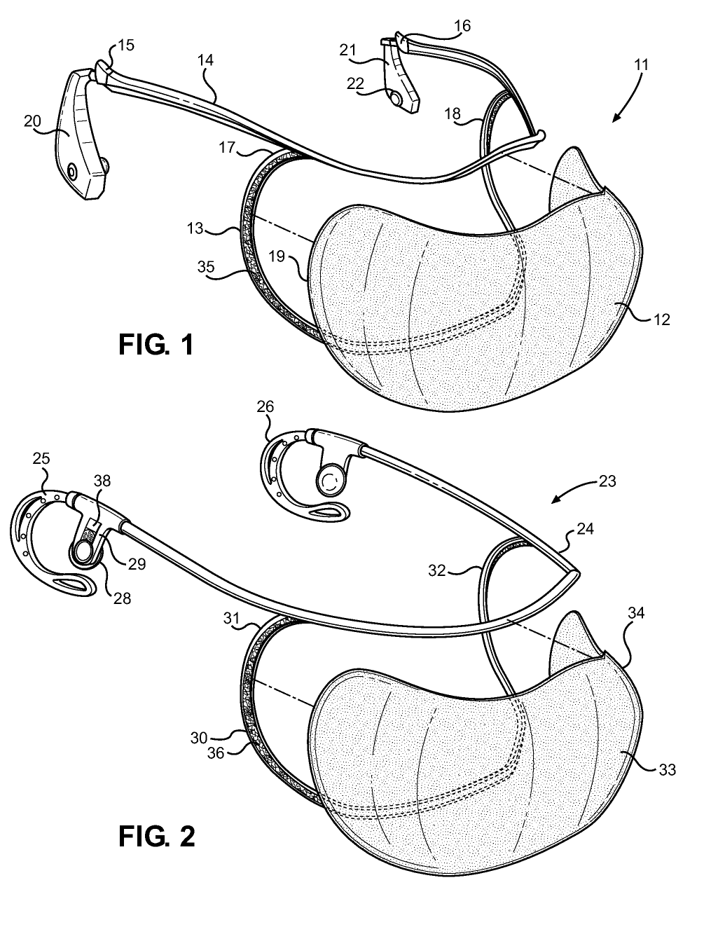

Referring now to FIG. 1, there is shown a first embodiment of the present invention. The present protective mask 11 comprises a mask frame having a hollow elongated upper support 14 and a lower support 13 attached thereto. The upper support 14 and the lower support 13 are semi-rigid so that the mask is comfortable to wear. The upper support 14 is curved and ergonomically shaped so that it is configured to span across a wearer's face. When viewed from the top, the upper support 14 is substantially U-shaped. The upper support 14 comprises a first end 15 and a second end 16. The hollow interior of the upper support 14 spans between the first end 15 and the second end 16. Each of the first end 15 and the second end 16 is adapted to hug the sides of the wearer's face, generally above the ears. In this way, the mask 11 is prevented from falling off of the wearer.

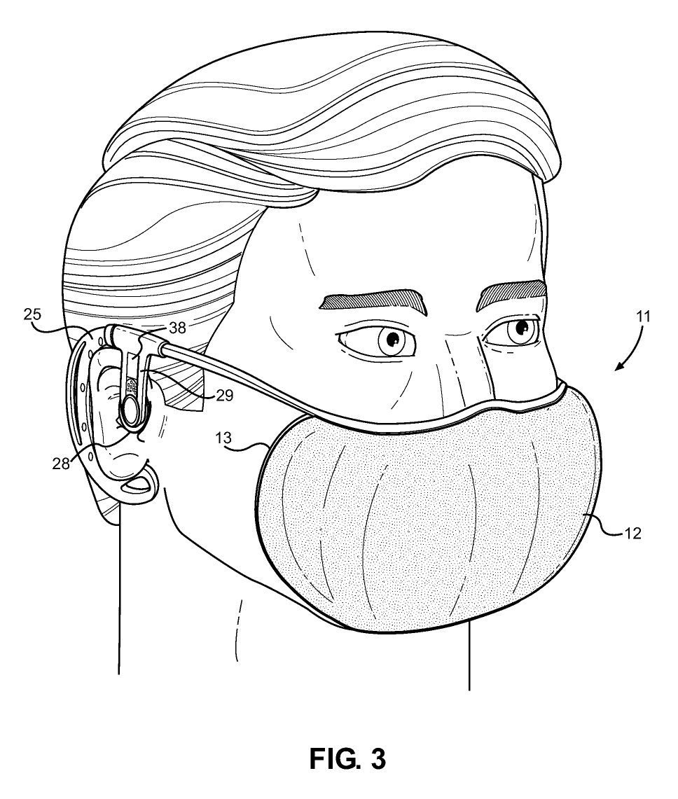

The lower support 13 extends below the upper support 14 and comprises a first end 17 and a second end 18. Each of the first end 17 and the second end 18 is attached to the upper support 14. It is contemplated that the upper support 14 and the lower support 13 are unitary in structure. The lower support 13 is configured so that it spans across the wearer's nose, mouth, and chin, as illustrated in FIG. 3. In this way, the lower support 13 is substantially U-shaped when viewed from the front. The lower support 13 comprises hook fasteners 35 along the length thereof. In this way, the lower support 13 can removably secure a face panel 12 thereon. Furthermore, it is contemplated that the upper support 14 may comprise hook fasteners between the first end 17 and the second end 18 of the lower support 13 so as to provide a complete seal around the peripheral edge of the face panel.

The face panel 12 comprises an outer surface that is coextensive with an inner surface, and includes a defined peripheral edge 19. The inner surface of the panel 12 is adapted to directly contact the wearer's face to cover the wearer's nose and mouth, and the outer surface of the panel 12 faces outward or away from the wearer's face. In a preferred embodiment, the face panel 12 comprises one or more layers that overlap one another. For example, the layers may include an inner layer that rests against a wearer's face, a filter layer that prevents microbes from passing through the face panel, and an outer layer. In this way, the panel 12 can filter the outside air as the wearer inhales, while blocking exhaled particles and respiratory excretions of the wearer. In one embodiment, the face panel 12 comprises a three-ply material that is made up from a melt-blown material placed between non-woven fabric. The melt-blown material acts as the filter that stops microbes from entering or exiting the face panel 12. In another embodiment, the face panel 12 comprises layers of mesh material.

In one embodiment, the peripheral edge 19 of the face panel 12 comprises loop fasteners thereon. The loop fasteners are disposed on the inner surface of the face panel 12 so that it can removably attach to the hook fasteners 35 on the lower support 13. The loop fasteners are positioned so that it does not extend substantially beyond the peripheral edge 19 and rub against the wearer's face. Alternatively, the peripheral edge 19 of the face panel 12 and the lower support 13 may comprise snap fasteners or other suitable fasteners. The face panel 12 can be easily interchanged and the protective mask 11 can be used with multiple face panels 12. This allows the wearer to simply discard a contaminated face panel 12 after use and replace it with a new face panel 12.

Each of the first end 15 and the second end 16 comprises an earphone 20 attached thereto. The earphone 20 comprises a housing 21 that is adapted to be positioned within or adjacent to the wearer's ears, as shown in FIG. 3. Without limitation, the housing 21 comprises an interior volume in which electrical components such as a speaker 22, a microphone, wireless headphone circuitry, a power source, and related components are enclosed. The electrical components in each earphone 20 may be connected by wires that run along the hollow interior of the upper support 14. In this way, the protective mask 11 can communicate with another electronic device with wireless capability, such as a mobile phone, an MP3 player, a tablet computer, or the like.

Referring now to FIG. 2, there is shown a perspective view of another embodiment of the present invention. The second embodiment of the protective mask 23 comprises an upper support 24 and a lower support 30 connected thereto. The lower support 30 comprises a first end 31 and a second end 32 connected to the upper support 24. The lower support 30 extends downward to span the lower portion of the wearer's face. The lower support 30 comprises hook fasteners 36 along the length thereof so as to removably attach a peripheral edge 34 of a face panel 33 thereto, wherein the peripheral edge 34 may comprise loop fasteners.

The upper support 24 also comprises a first end 25 and a second end 26, wherein each of the first 25 and second ends 26 is configured to wrap around the wearer's ears so that the earphones 29 extend upward from the bottom portion of the wearer's ears. Thus, each of the first and second ends 25, 26 include a C-shape that can be disposed around a user's ears. The earphones 29 comprise a housing 27 with an on/off button 38, a speaker 28, a microphone, wireless headphone circuitry, a power source, and related components imbedded therein. The speaker 28 is adapted to be placed within the user's ear to allow the user to more easily hear the sound produced thereby.

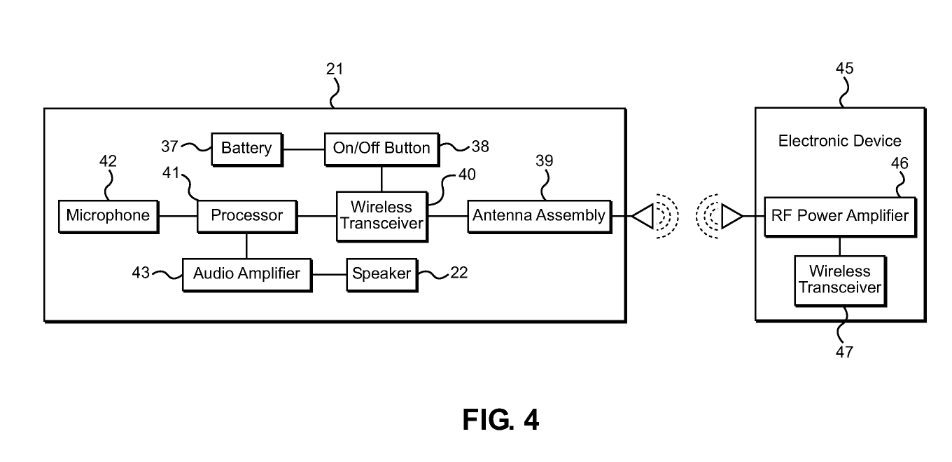

Referring now to FIG. 4, there is shown an exemplary schematic diagram of the earphone of the present invention. Each earphone comprises a housing 21 with an interior volume having electrical components such as a speaker 22, a microphone 42, wireless headphone circuitry, a power source 37, and related components therein. The electrical components of the present invention are internally powered via a battery 37 so that the device is portable. The speaker 22 is connected to an audio amplifier 43 that is in communication with a processor 41. The processor is connected to the wireless headphone circuitry comprising a wireless transceiver 40 having an antenna assembly 39. The wireless transceiver 40 and the antenna assembly 39 communicate with an external electronic device 45 having wireless capability. Without limitation, the electronic device 45 may comprise a mobile phone, an MP3 player, or a tablet computer, among others. It is contemplated that the electronic device 45 may generally comprise a wireless transceiver 47 in communication with an RF power amplifier 46, which converts a low-power radio-frequency signal into a larger signal of a significant power to drive the antenna assembly 39.

The wireless transceiver may be operable by means of an on/off button 38. In some embodiments, the on/off button 38 may be accessible from the exterior of the housing 21. When the on/off button 38 is actuated, a wireless connection is established between the electronic device 45 and the wireless headphone circuitry so that the protective mask and the electronic device 45 are paired. Thereafter, an audio signal from the electronic device 45 can be transmitted by means of the RF power amplifier 46 and the wireless transceiver 47 so that the antenna assembly 39 can convert the input audio signal and apply the signal to the transceiver 40. The processor 41 can decode the received input signal so that the output signal can be amplified and emitted through the speaker 22 as audible sound. In this way, the wearer can listen to music or an audio recording that is transmitted to or stored in the electronic device 45 without physically connecting to the same. Alternatively, the electronic device 45 may comprise text to speech means so that the wearer can listen to texts and communicate with the electronic device 45 in various ways.

Additionally, the microphone 42 enables the wearer to speak to the electronic device 45 without physically connecting thereto. In one embodiment, the protective mask can be used with an electronic device 45 having voice command and dictation means. The wearer can speak into the microphone 42 so that the processer can process the input signal comprising the wearer's speech and convert it into an output signal that can be transmitted by means of the transceiver 40 and the antenna assembly 39. The electronic device 45 can convert the received signal into a text, thereby eliminating the need for the wearer of the protective mask to manually enter text into the electronic device 45. In this way, the present invention allows the wearer to communicate with or otherwise utilize electronic devices 45 in a hands-free manner.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above descriptions then, it is to be realized that the optimum dimensional relationships for the parts of the invention, to include variations in size, materials, shape, form, function, and manner of operation, assembly and use, are deemed readily apparent and obvious to one skilled in the art, and all equivalent relationships to those illustrated in the drawings and described in the specifications are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A protective mask with imbedded functionality, comprising:
an upper support having a first end and a second end;
a lower support having a first end and a second end;
said lower support extending downward from said upper support;
each of said first end of said lower support and said second end of said lower support attached to said upper support;
a face panel removably attached to said lower support to cover a wearer's nose and mouth, leaving a wearer's eyes uncovered;
an earphone having a housing with an interior volume enclosing a wireless headphone circuitry, a speaker, and a battery;
said earphone attached to each of said first end of said upper support and said second end of said upper support.

2. The protective mask of claim 1, wherein each of said first end of said upper support and said second end of said upper support is curved to wrap around a wearer's ears.

3. The protective mask of claim 1, wherein said face panel is removably attached to said lower support by means of hook fasteners and loop fasteners.

4. The protective mask of claim 1, wherein said face panel comprises an inner layer and an outer layer to filter outside air, while blocking exhaled particles and respiratory excretions.

5. The protective mask of claim 1, wherein said wireless headphone circuitry comprises a wireless transceiver and an antenna assembly adapted to receive a signal from an external mobile electronic device and send a signal to said external mobile electronic device.

6. The protective mask of claim 1, further comprising:
an audio amplifier connected to said speaker;
a processor in connection with said audio amplifier and said wireless headphone circuitry.

7. The protective mask of claim 1, further comprising a microphone;
a processor in connection with said microphone and said wireless headphone circuitry.

8. The protective mask of claim 1, further comprising an on/off button connected to said battery;
said on/off button initiating a wireless connection between said wireless headphone circuitry and an external electronic device.
